(19) United States
(12) Patent Application Publication
(10) Pub. No.: US 2014/0222591 A1
(43) Pub. Date: Aug. 7, 2014

(54) Systems and Methods for Post-Payment Gift Cards

(71) Applicants: Leif Alexander Baradoy, Victoria (CA); Peter Alexander Didrikson Locke, Victoria (CA); Anthony Ryan McDonald, Calgary (CA); Graham Bruce Baradoy, Calgary (CA)

(72) Inventors: Leif Alexander Baradoy, Victoria (CA); Peter Alexander Didrikson Locke, Victoria (CA); Anthony Ryan McDonald, Calgary (CA); Graham Bruce Baradoy, Calgary (CA)

(21) Appl. No.: 14/093,386

(22) Filed: Nov. 29, 2013

Related U.S. Application Data
(60) Provisional application No. 61/761,414, filed on Feb. 6, 2013.

(51) Int. Cl. G06Q 30/02

(52) U.S. Cl. CPC G06Q 30/0277
USPC 705/14.72

(57) ABSTRACT

According to one aspect, a post-payment gift card system in which the benefactor pays the value of the gift card at the time that the recipient redeems the gift card with the merchant. In some cases, the benefactor may create a gift card campaign using a gift card system. In some cases, the gift card system may include a user account. The user account may include attributes such as user identification information, user contact information, one or more user payment methods, payment method information, a user account good status indicator, and a user account trust indicator.

### RELATED APPLICATIONS

This application claims the benefit of U.S. Provisional Patent Application Ser. No. 61/761,414 filed Feb. 6, 2013 and entitled SYSTEMS AND METHODS FOR POST-REDEMPTION PAYMENT GIFT CARDS, the entire contents of which are hereby incorporated by reference herein for all purposes.

### TECHNICAL FIELD

The embodiments herein relate to gift card systems, and in particular to systems and methods for administering gift cards, including gift card campaigns.

### INTRODUCTION

Gift cards or gift certificates generally allow a gift giver to provide a non-monetary gift to a gift recipient without specifying the non-monetary gift itself. It is common practice for retailers to make a gift card or gift certificate available for sale that is redeemable for goods or service offered through that retailer or another entity.

With this type of conventional gift card, a gift giver can allow for some flexibility in the gift giving experience, since the recipient is able to choose items offered by the specific retailer, yet the gift giver can still personalize the gift by defining the scope of the gift by selecting the particular retailer. Some gift cards often take the form of physical paper or plastic cards redeemable by the retailer. Alternatively, in some cases electronic or virtual gift cards can be used, which may include for example an electronic code that is redeemed by entering the code into an electronic commerce system.

### BRIEF DESCRIPTION OF THE DRAWINGS

Various embodiments will now be described, by way of example only, with reference to the following drawings, in which:

FIG. 1 is a schematic diagram of a gift card system according to some embodiments.

FIG. 2a is a flow diagram of a gift card campaign creation method according to some embodiments;

FIG. 2b is a flow diagram of a part of a gift card campaign creation method according to some embodiments;

FIG. 3a is a flow diagram of a gift card redemption method according to some embodiments;

FIG. 3b is a flow diagram of a gift card redemption method according to some embodiments;

FIG. 3c is a flow diagram of a part of a gift card redemption method according to some embodiments;

FIG. 3d is a flow diagram of a step in a gift card redemption method according to some embodiments;

FIG. 4 is a schematic diagram illustrating exemplary modules provided by a gift card system such as, for example, the system in FIG. 1;

FIG. 5 is a schematic diagram illustrating one exemplary configuration of a user account creation module;

FIG. 6 is a schematic diagram illustrating one exemplary configuration of a user account maintenance module;

FIG. 7 is a schematic diagram illustrating one exemplary configuration of a gift card campaign creation module;

FIG. 8a is a schematic diagram illustrating one exemplary configuration of a gift card creation module;

FIG. 8b is a schematic diagram illustrating one exemplary configuration of a gift card creation module; and

FIG. 9 is a schematic diagram illustrating one exemplary configuration of a gift card redemption module.

Throughout the drawings, it should be noted that like reference numbers may be used to depict the same or similar elements, features, and structures, where appropriate.

### DESCRIPTION OF SOME SPECIFIC EMBODIMENTS

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both.

In some cases, embodiments may be implemented in one or more computer programs executing on one or more programmable computing devices including at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

As introduced above, the use of gift cards can provide a gift giver with flexibility in the gift giving experience, since the gift giver can select a particular retailer (thus providing some constraints on the gift) without specifying the goods to be purchased.

It is common practice for gift cards to be purchased for their full value prior to the gift card being redeemed. For example, if a gift card with a value of $50 is purchased at Store A, then Store A has received $50 in revenue, regardless of when or if the gift card is redeemed for goods or services. Gift cards such as this can be defined as “pre-pay” gift cards.

In some cases, instead of pre-pay gift cards, post-pay gift cards may be provided. In particular, a post-pay gift card solves the problem of a gift giver spending money with nothing in return, which occurs when a pre-pay gift card is never redeemed.

In a system that uses post-pay gift cards, a credit card, checking account (or other account) belonging to or associated with the gift giver may be associated with the gift card, and that credit card, checking or other account is not charged until some time during the redemption process (e.g., when the gift card recipient actually redeems the gift card). In that sense, a post-pay gift card can be considered as “free” to the gift giver up until such time as the gift card is actually redeemed.

Despite the potential of a post-pay gift card, there are some drawbacks to some post-pay gift card systems. For example, many systems rely on cooperation with merchant systems, such as sales and inventory systems. However, these systems are normally not suitable for use with multiple different merchant systems in a seamless and timely manner, since different systems are often incompatible.

Furthermore, systems that consider individual gift card transactions may not be suitable for creating and deploying gift card campaigns that include multiple gift cards given to multiple users.

In some gift card systems, a gift card is purchased by a first user, the benefactor (and often the gift giver), and then given to a second user, the recipient. In some cases, the gift card may be redeemable through a third user (often a merchant). In some cases the gift card may have a specific value, although this is not necessarily required.

In some cases, the benefactor may purchase at least one gift card for at least one recipient as part of a gift card campaign. In some cases, a gift card system may be a post-payment gift card system in which the benefactor pays the value of the gift card at the time that the recipient redeems the gift card with the merchant (i.e., after the gift card has been created). In some instances, a service charge (normally a small fee) may be paid by the benefactor when the gift card is created, and before the recipient redeems the gift card.

In some cases, the benefactor may create a gift card campaign using a gift card system. For example, the benefactor may connect to the gift card system over a communications network (e.g., the Internet) using any suitable approach, such as a communications device, smartphone or computer, in order to create a gift card campaign. In some cases, a benefactor may create multiple gift card campaigns, and may create different gift card campaigns at different times.

In some cases, the gift card system may include a user account. According to some embodiments, the user account may include attributes such as user identification information, user contact information, one or more user payment methods (such as a credit card, checking account, etc.), payment method information (such as a credit card number), a user account good status indicator, and a user account trust indicator.

The user account may be created, and the user account attributes can be assigned, for example, by a user account creation module.

In some cases, a user account maintenance module may be included in the gift card system in order to perform various functions for the system. For example, the gift card maintenance module may perform a function of periodically validating the user account payment method and payment method information, and updating the user account good status indicator. The gift card maintenance module may perform the function of periodically updating the user account trust indicator.

In some embodiments, a gift card system may allow a user associated with a user account to create a gift card campaign. The gift card campaign may include attributes such as a first user associated with a user account (the benefactor), at least one second user (one or more recipient(s)), recipient contact information, at least one gift card identification information associated with the gift card campaign, gift card campaign dates, and other attributes. In some instances, the gift card campaign can be created and the gift card campaign attributes can be assigned by a gift card campaign creation module.

A gift card campaign includes one or more gift cards. A gift card may include attributes such as a benefactor identification information, recipient identification information, recipient contact information, a gift card value, and gift code. In some embodiments, the gift cards can be created and the gift card attributes can be assigned by a gift card creation module.

A gift card system will generally provide for the redemption of a gift card by a merchant, or by a recipient at a merchant location. Redemption, generally, includes the step of providing a recipient with an item from the merchant, the value of the item being determined using the gift card value, and the step of cancelling, voiding, or terminating the gift card so that it cannot be subsequently redeemed for a value not intended by the benefactor or merchant.

In some cases, a gift card redemption module may provide some gift card redemption functionality to the gift card system. For example, the gift card redemption module may allow for the value of the gift card to be charged to the benefactor, the benefactor's user account, or the benefactor's credit card, during the redemption process.

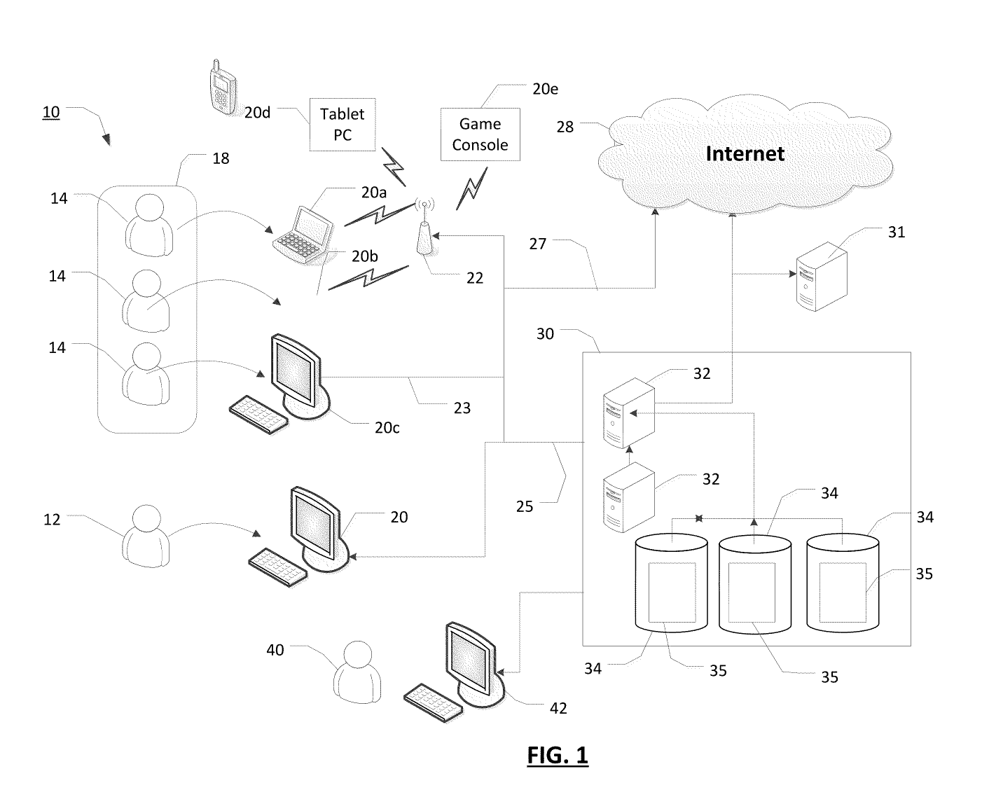

Referring now to FIG. 1, illustrated therein is a gift card system 10 according to some embodiments. The system 10 as shown is an electronic gift card system. However, in other instances the system 10 may not be limited to electronic gift card systems and the system 10 may be other types of systems, including for example physical gift card systems.

Using the system 10, a user 12 may communicate with a gift card service provider 30 in order to create and deliver gift cards. In some cases, the gift card service provider 30 may be part of (or associated with) a traditional “bricks and mortar” merchant (e.g., a retail store, shopping mall, restaurant, and the like), another entity that provides gift card services (e.g., a marketing organization, charity, and the like), or may be an independent gift card service provider.

It should be understood that a gift card is not limited to gift cards offered by one individual to another in a social relationship. The gift card may generally include any form of coupon, token, code, or the like, offered by an entity of any type for the redemption of a specified item or of a specified value. For example, a gift card may be provided by a merchant as a reward or incentive to customers as part of a marketing campaign, or by an employer to show appreciation to employees.

In some embodiments, one or more gift card campaigns can be defined that include one or more of the users 14. For example, as shown in FIG. 1, the users 14 may be grouped together in a group 16 associated with a particular gift giving campaign. A first user 12 or “benefactor” is responsible for creating the gift card campaign, pays the cost of the gift cards in the campaign, and interacts with the gift card service provider 30.

The second users 14 or “recipients” receive the gift cards created by the first user 12 by interacting with the gift card service provider 30.

In order to redeem the gift card, the second users 14 also communicate with a third user 40, typically a “merchant”. The third user 40 redeems the gift card by interacting with the gift card service provider 30.

The users 12, 14, and 40 may interact with the system using various computing or communications devices. The recipients 14, for example, may use a laptop 20a, a tablet computer 20d, or a game console 20e, which wirelessly coupled to an access point 22 (e.g. a wireless router, a cellular communications tower, etc.), a wirelessly-enabled Personal Data Assistant (PDA) or a smart phone 20b, a terminal 20c operating over a wired connection 23, and so on.

The benefactor 12, for example, may use terminal 20, or any similar device as used by the recipients 14. Similarly, the merchant 40, for example, may user terminal 42 or any similar device as used by the recipients 14 or benefactor 12.

In some embodiments, the devices 20a-20e may have dedicated software installed therein (e.g., a software client) to access the gift card service provider 30. In other embodiments, the benefactor 12, recipients 14, or merchant 40 may access the gift card service provider using a web browser application through a web interface, or using other techniques.

According to some embodiments, gift card service provider 30 may include computer and networking equipment. For example, one or more servers 32 may be used along with one or more storage devices 34, which may store, among other information, one or more databases 35. The gift card system 10 may include any number of databases 35 distributed over any number of storage devices 34 or any number of servers 32. Additional computer equipment 31 may be used, for example, to provide redundancy, back-up functionality, improved efficiency, or other benefits to gift card system 10.

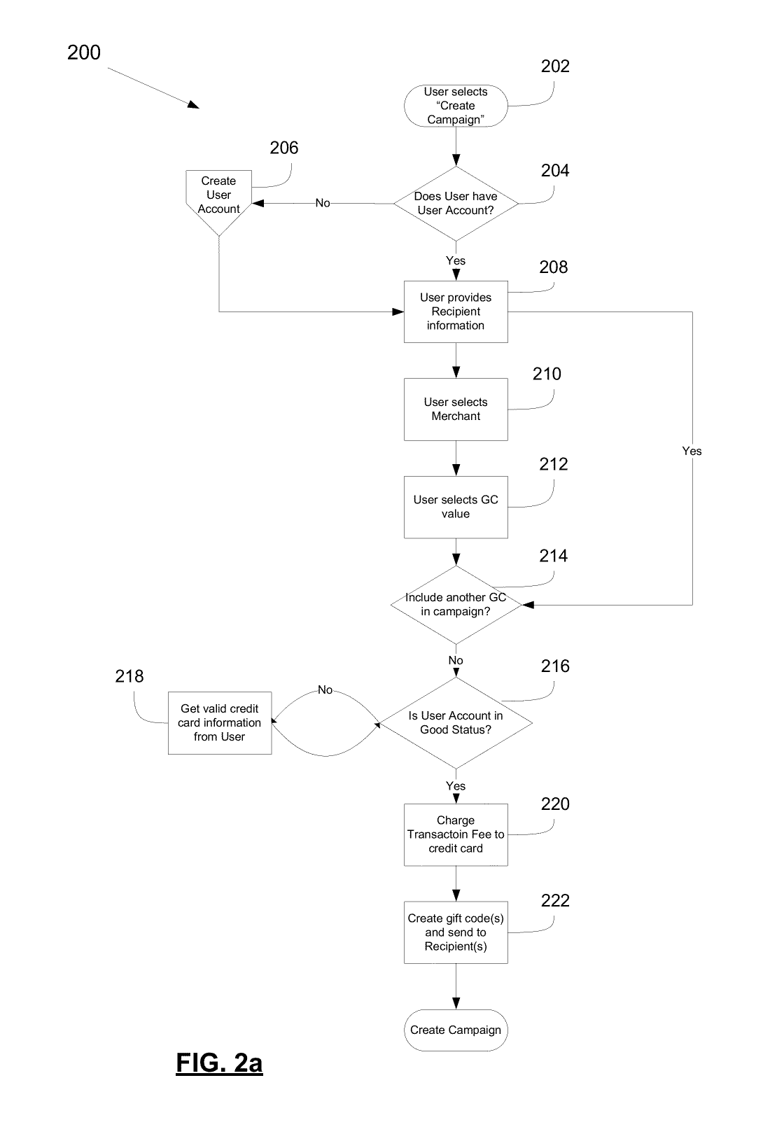

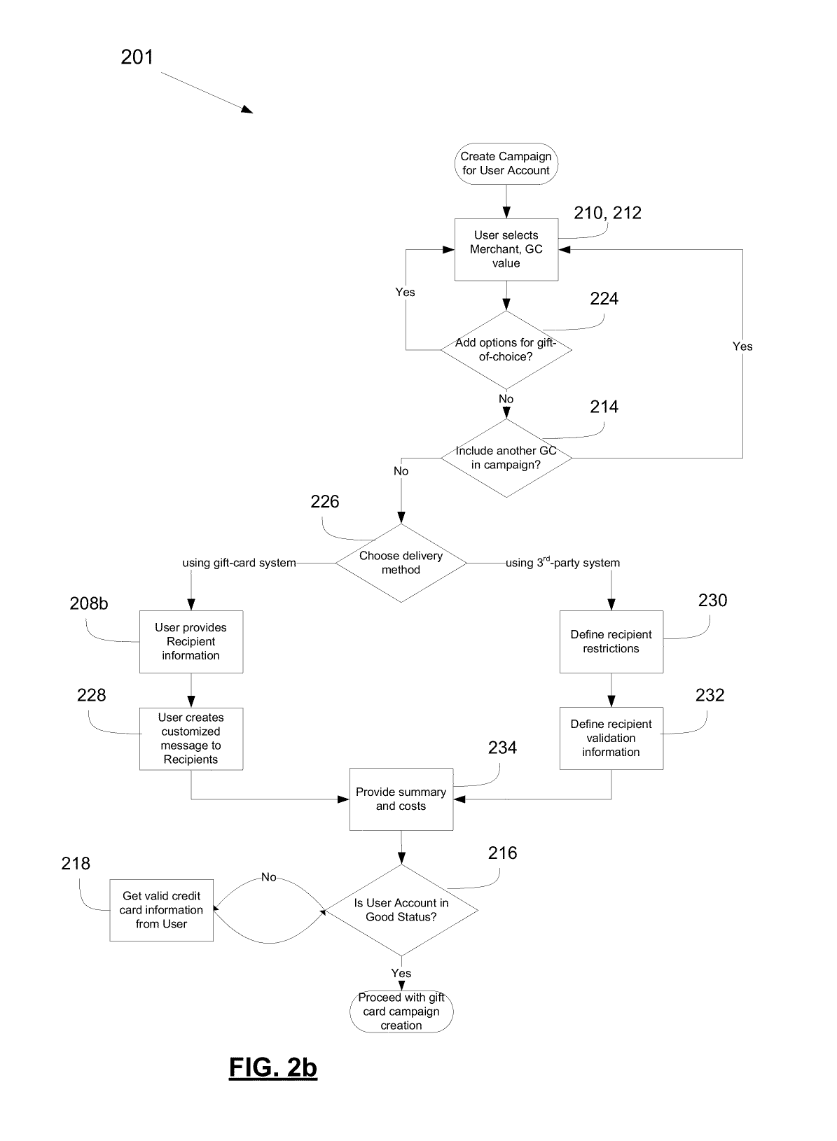

Referring now to FIG. 2A, illustrated therein is a gift card campaign creation method 200 according to some embodiments. The method 200 may be executed by one or more processors of the system 10 shown in FIG. 1 and described herein above.

At step 202 a user (for example the benefactor) initiates the process of creating a gift card campaign.

At step 204, the gift card system verifies whether the user is associated with an existing user account. If the user is not associated with an existing user account, then the user is prompted to create a user account (as may be accomplished for example using the user account creation module in step 206).

Once verification has been received that the user is associated with a user account, the method 200 proceeds.

At steps 208, 210, and 212 respectively, the gift card system prompts the user to enter information pertaining to the gift card recipient, the gift card merchant, and the gift card value. In different embodiments, the user may be prompted to enter this, and other information, in any order, such as being prompted to enter the gift card value associated with 212 prior to other information.

At step 214, the gift card system prompts the user to indicate whether there will be additional gift cards included in the present campaign. If the user chooses to add more gift cards to the present campaign, then steps 208, 210, and 212 may be repeated for each gift card that the user chooses to add to the campaign, until no more gift cards are to be added.

In some embodiments, any of steps 208, 210, or 212 may be undertaken once for each gift card campaign, and in some embodiments, any of steps 208, 210, or 212 may be undertaken once for each gift card. For example, if every gift card included in a gift card campaign is redeemable for an identical value or item, then the user might only enter the gift card value (e.g. as associated with 212) a single time during the creation of the gift card campaign.

When the gift card system verifies that the user does not intend to add more gift cards to the present campaign, the method proceeds from step 214 to step 216. At step 216, the gift card system verifies that the present user account is in good status. For example, this may include verifying that the credit card associated with the user account is valid. If the user account is not in good status, then the gift card system proceeds to step 218, wherein the gift card system prompts the user to return the user account to good status, for example, by providing valid (or updated) credit card information associated with the user account.

However, when the gift card system verifies that the present user account is in good status, the method proceeds to step 220. At step 220, the gift card system may charge a transaction or service fee to the credit card associated with the present user account. For example, the transaction fee may be a portion of the gift card value, or may be determined independently of the gift card value (e.g., the transaction fee may be a flat fee of $1.00).

In some embodiments, the transaction fee may be a fee in addition to the gift card value.

At step 222, gift codes are created for each gift card in the present campaign, and the gift codes are delivered to the recipients. For example, the gift codes may be delivered by way of electronic mail, social networks, public mail, a courier, a proprietary delivery system, or other means of communication.

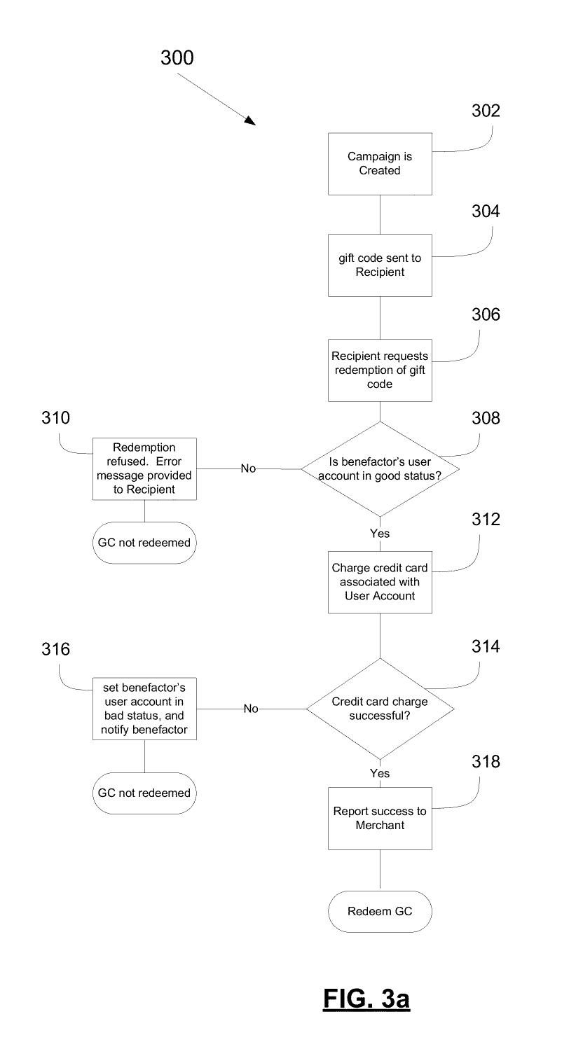

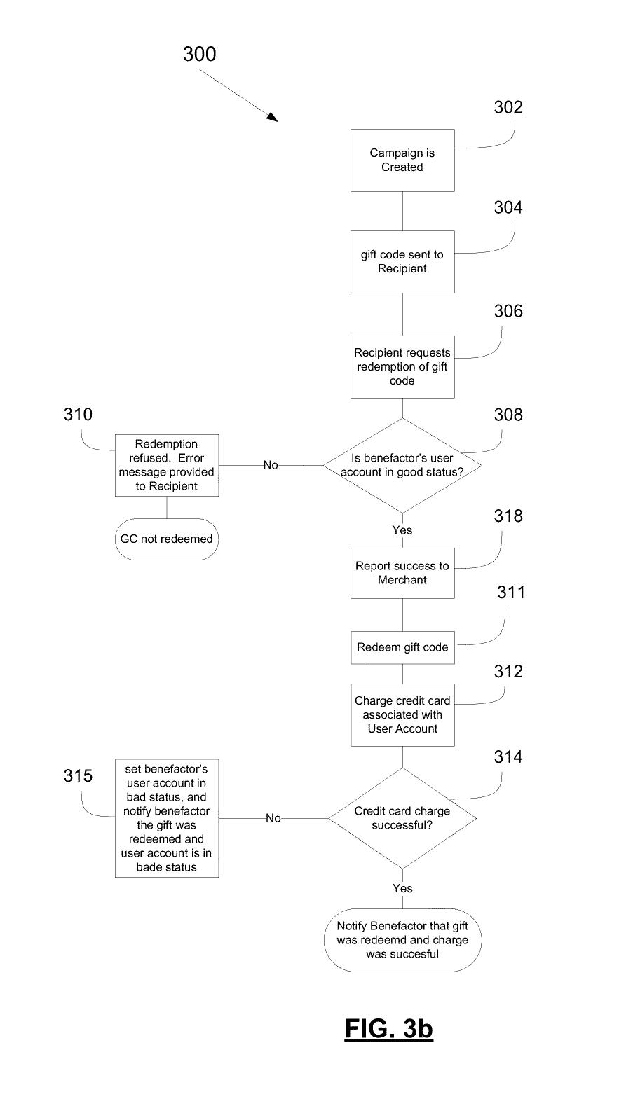

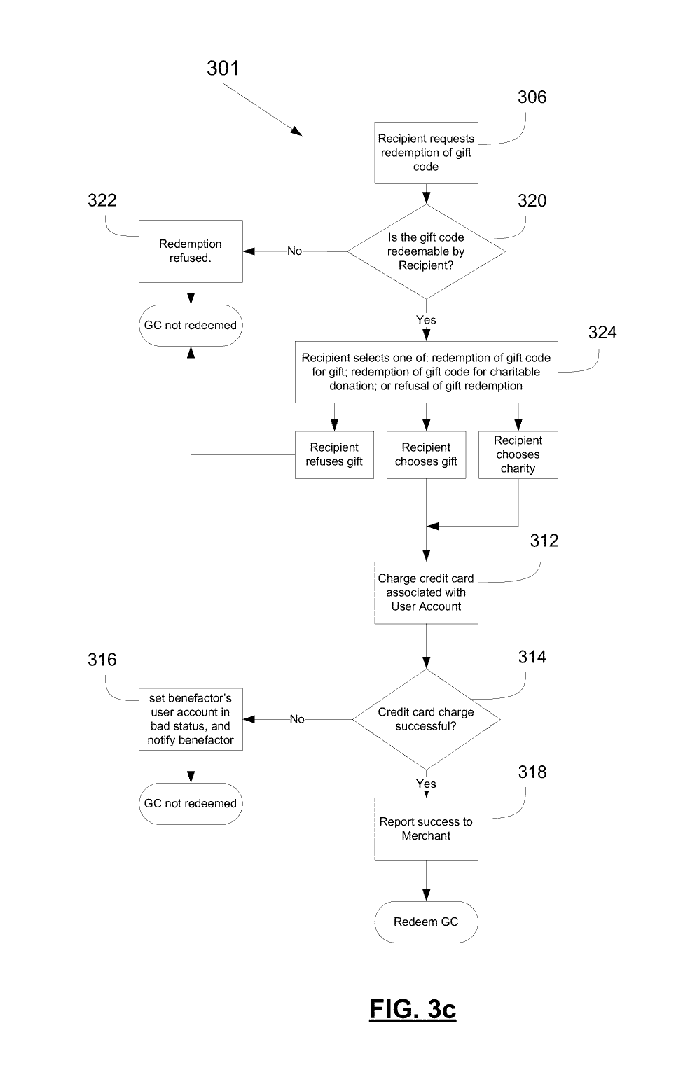

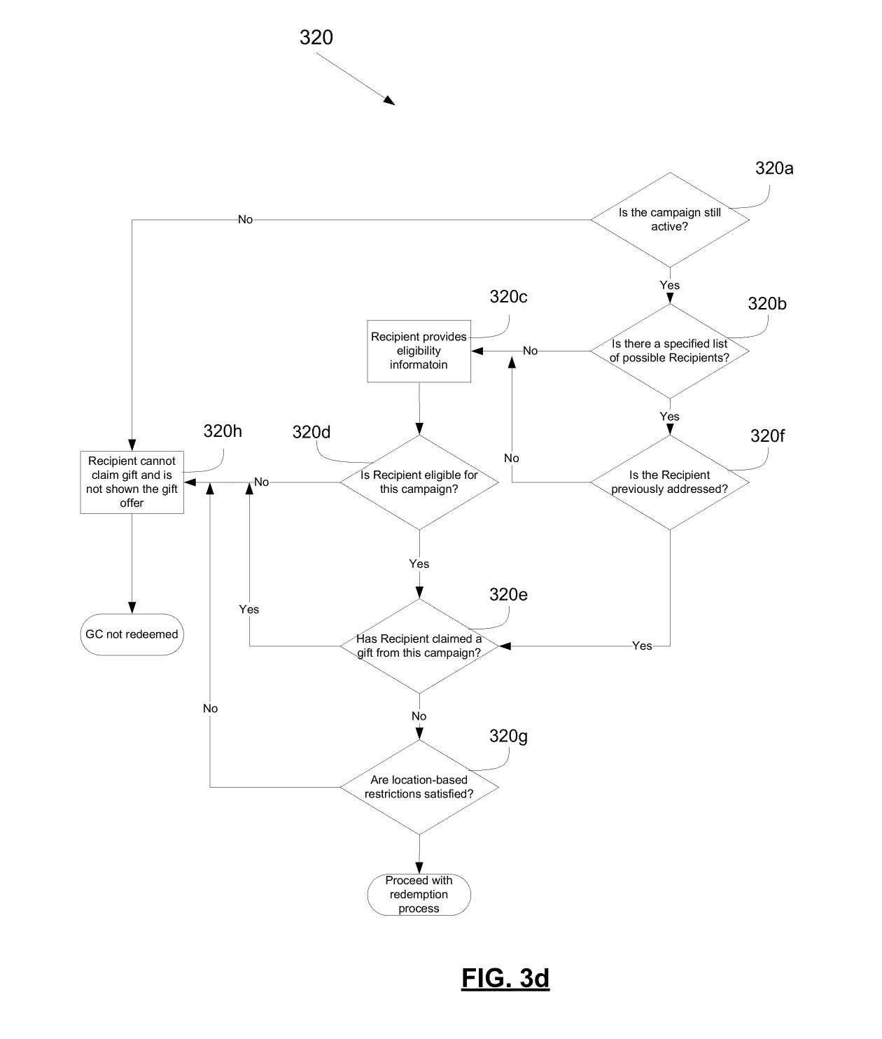

Referring now to FIG. 3a, illustrated therein is a method 300 for redeeming a gift card according to some embodiments. The method 300 may be executed by one or more processors of the system 10 shown in FIG. 1 and as described herein.

The method 300 beings at step 302, in which the gift card campaign is created. For example, the gift card campaign may be created by a gift card campaign creation module.

At step 304, a gift code is sent to a recipient.

At step 306, a request to redeem the gift code is received, typically from the recipient. For example, the gift card recipient may identify the gift code to the merchant, and the merchant may enter the gift code in the gift card system.

In other embodiments, the gift code may be communicated to the gift card system through other communications means, such a proprietary communications system or a web browser provided over the internet.

At step 308, the gift card system verifies that the user account associated with the benefactor is in good status. If the benefactor's user account is not in good status, then the gift card redemption may be temporarily refused, as in step 310, until such time as the benefactor's user account is returned to good status.

When the benefactor's user account is verified as being in good status in step 308, the gift card system proceeds to charge the credit card associated with the benefactor's user account as in step 312.

In step 314, the gift card system verifies the success of the credit card charge as in step 312. If the charge was not successful, then the benefactor's user account may be set to bad status, and the benefactor may be notified of the change in their status.

If the charge was not successful, then, according to some embodiments, the gift card system may refuse the gift code redemption.

When, in step 314, the gift card system verifies that the credit card charge of step 312 was successful, the gift card system will generally report to the merchant that the gift code can be redeemed. The merchant can then redeem the gift code as in step 316.

However, if the credit card charge of step 312 was unsuccessful, then the gift card should not be redeemed, and the benefactor's user account may be set to bad status.

Referring now to FIG. 3b, illustrated therein is a method 300 for redeeming a gift card according to some embodiments. According to some embodiments, the method 300 may include reporting a successful redemption to the merchant at 318 after verifying that the benefactor's user account is in good status in 308, and prior to charging the credit card associated with the user account in 312. In this case, the gift code may be redeemed at 311 prior to the benefactor's credit card being charge. If the credit card charge of 312 is not successful at 314, then at 315, the benefactor is notified that the gift was redeemed and that the benefactor's user account is in bad status.

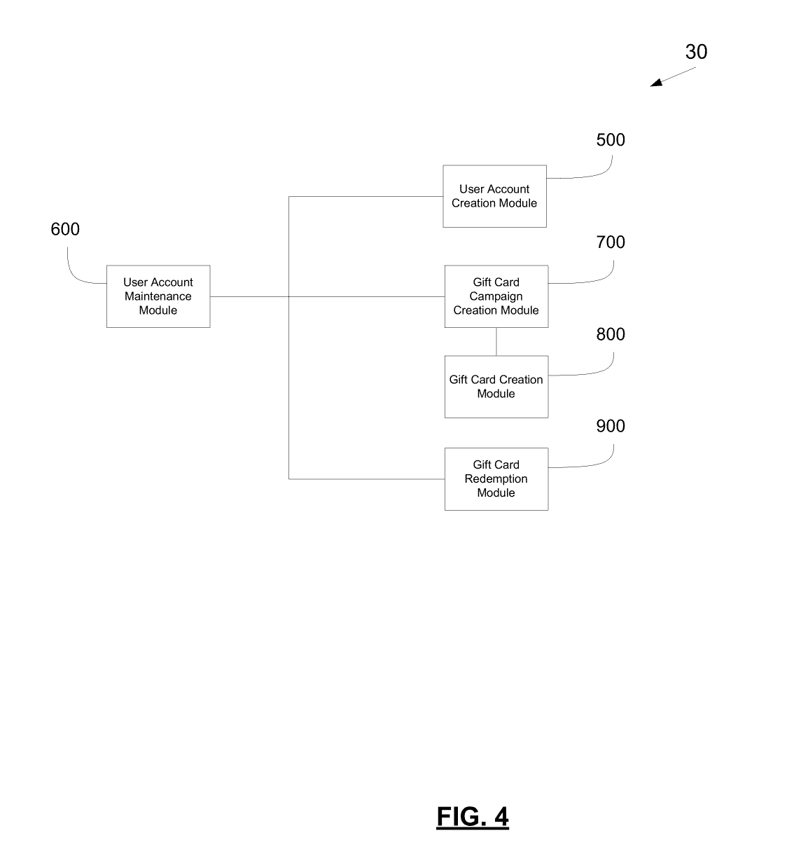

In some embodiments, the above exemplary methods may be carried out by one or more modules as described herein, such as a user account creation module 500, a user account maintenance module 600, a gift card campaign module 700, a gift card creation module 800, and a gift card redemption module 900. FIG. 4 provides an illustration of one exemplary way in which these modules can be arranged in a gift card system.

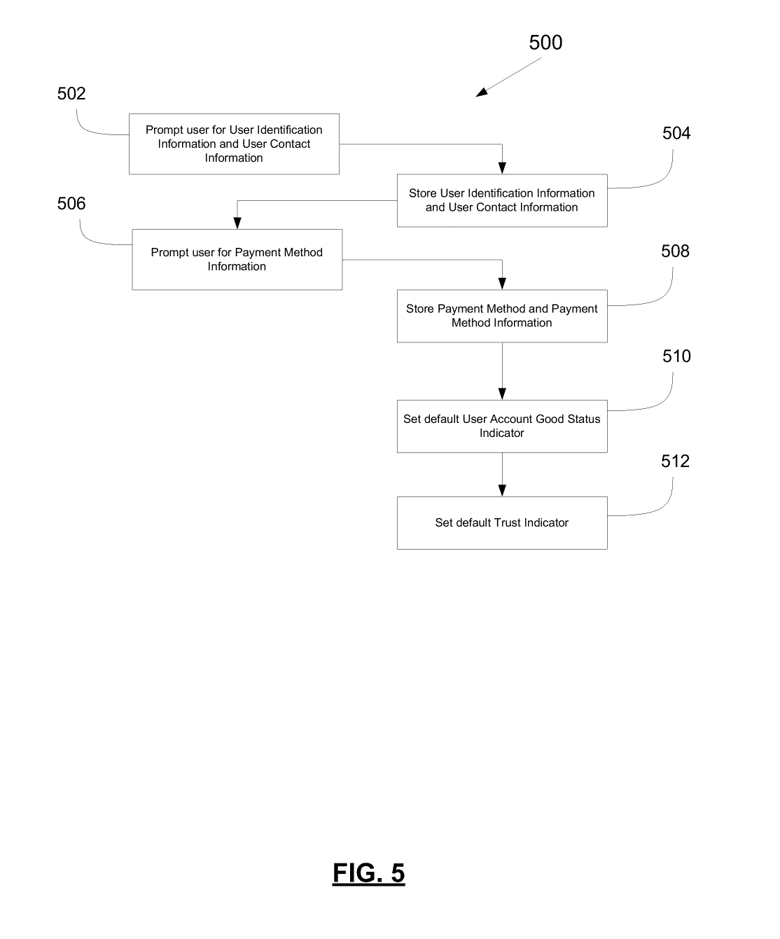

Referring now to FIG. 5, illustrated therein is a schematic diagram of an exemplary configuration of a user account creation module 500. The module starts by prompting the user for identification and contact information at 502, which is subsequently stored at 504.

Next, at 506, the user is prompted to provide payment method information, which is subsequently stored at 508. For example, payment method information may be credit card information, bank account information, information pertaining to a financial transaction service such as PayPal or similar.

At 510, the module sets a default value for the user account good status indicator, for example “good” or “bad”.

At 512, the module sets a default value for the user account trust indicator, for example “trusted” or “not trusted”.

According to some embodiments, the trust indicator may include a trust score value. In some embodiments, the default trust score value (or default trust indicator), is set to zero, indicating “fully trusted”. In such a case, a higher trust score generally indicates less trust.

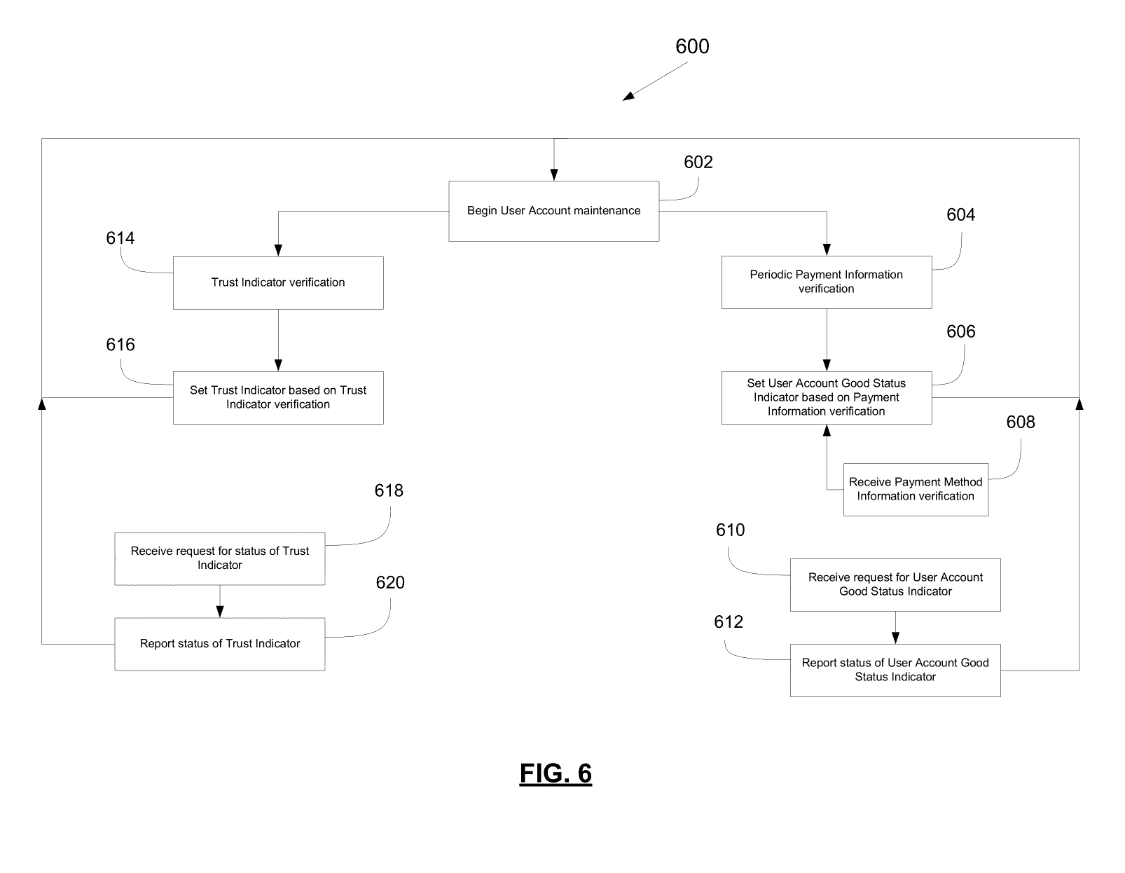

Referring now to FIG. 6, illustrated therein is a schematic diagram of an exemplary configuration of a user account maintenance module 600. According to some embodiments, the user account maintenance module may repeatedly operate in cycles during the existence of a user account.

In some cases, a cycle may begin, for example, at 602, and may be triggered by the creation of a user account, the completion of a previous cycle, or another event.

The user account maintenance module 600 may conduct periodic verification of payment method information associated with a user account. For example, if the payment method information associated with a user account is a credit card, than the validity of the credit card information may be determined at 604.

In some embodiments, the validation of payment method information may also include verifying that sufficient credit is available. The payment method information verification of 604 may be periodically conducted while the user account has associated unredeemed gift cards, or during the existence of the user account, or in association with another event.

If the payment information verification of 604 determines that the payment information is not valid, then the user account good status indicator may be set, for example, to “bad” at 606. If the payment information verification of 604 determines that the payment information is valid, then the user account good status indicator may be set, for example, to “good” at 606.

According to some embodiments, the user account maintenance module 600 may monitor the validity of the payment method information, and update the good status indicator accordingly. The user account maintenance module 600 may also receive information, for example, from other modules or sources, indicating that the payment method information is not valid. For example, at 608, information pertaining to the verification of the payment method information may be received. The received information at 608 may, in turn, cause the user account good status indicator to be set at 606.

In some cases, the information received at 608 may be provided during a payment transaction, such as during a gift card campaign creation event, a gift card redemption event, or other event.

In some exemplary embodiments, the user account maintenance module 600 may receive a request to report the status of the user account good status indicator, as in 610. In response, the user account maintenance module 600 may report the status of the user account good status indicator, as in 612. For example, the request to report the status of the user account good status indicator may be received from a gift card campaign creation event, a gift card redemption event, or other event.

In some cases, the user account maintenance module 600 may include the verification of a user account trust indicator, as in 614. The user account trust indicator may be accordingly set, as in 616.

The trust indicator may be calculated by assigning individual weighting factors to particular user events that are understood to be related to trust. For example, the trust indicator may be adversely affected (e.g. the trust score value may be increased) upon a failed attempt to charge or verify a credit card associated with a user account. The particular nature of the failed attempt may further determine the extent to which the trust indicator is affected. For example, a failure due to a bad CVC code may be associated with one weighting factor, a failure due to a bad address may be associated with another weighting factor, and a failure due to a declined credit card (e.g. insufficient balance) may be associated with another weighting factor. Furthermore, the particular weights may be adjusted over time.

The trust indicator may be calculated based on time proximity to particular events. For example, if a user attempts to associate more than a certain number of credit cards with a user account within a certain period of time, the trust indicator may be adversely affected (e.g. the trust score value may be increased). If more than a certain number of gift card campaigns are created in a short period of time, then the trust core value may be increased more than if the same number of campaigns had been created over a longer period of time.

The trust score value and trust indicator may be determined according to a particular equation. According to some embodiments, an example trust equation is given by:

Trust score=Σᵢ₌₀^{C}Wᵢ·e^{X·i}

where: C is the total number of events in a predetermined rolling window length; Wᵢ is the weighting factor for event i, and X is a predetermined exponent multiplier for the event type corresponding to event i.

In some exemplary embodiments, the user account maintenance module 600 may receive a request to report the status of the user account trust indicator, as in 618. In response, the user account maintenance module 600 may report the status of the user account trust indicator, as in 620. For example, the request to report the status of the user account trust indicator may be received from a gift card campaign creation event, a gift card redemption event, or other event.

In some cases, a user account maintenance module 600 may operate in a continuous cycle, or as a periodic cycle, or as any other type of event. The event of receiving a request for status of the trust indicator, as in 618, or good status indicator, 610, may interact with the module 600 as interrupt events, as module initiation events, or as another type of event.

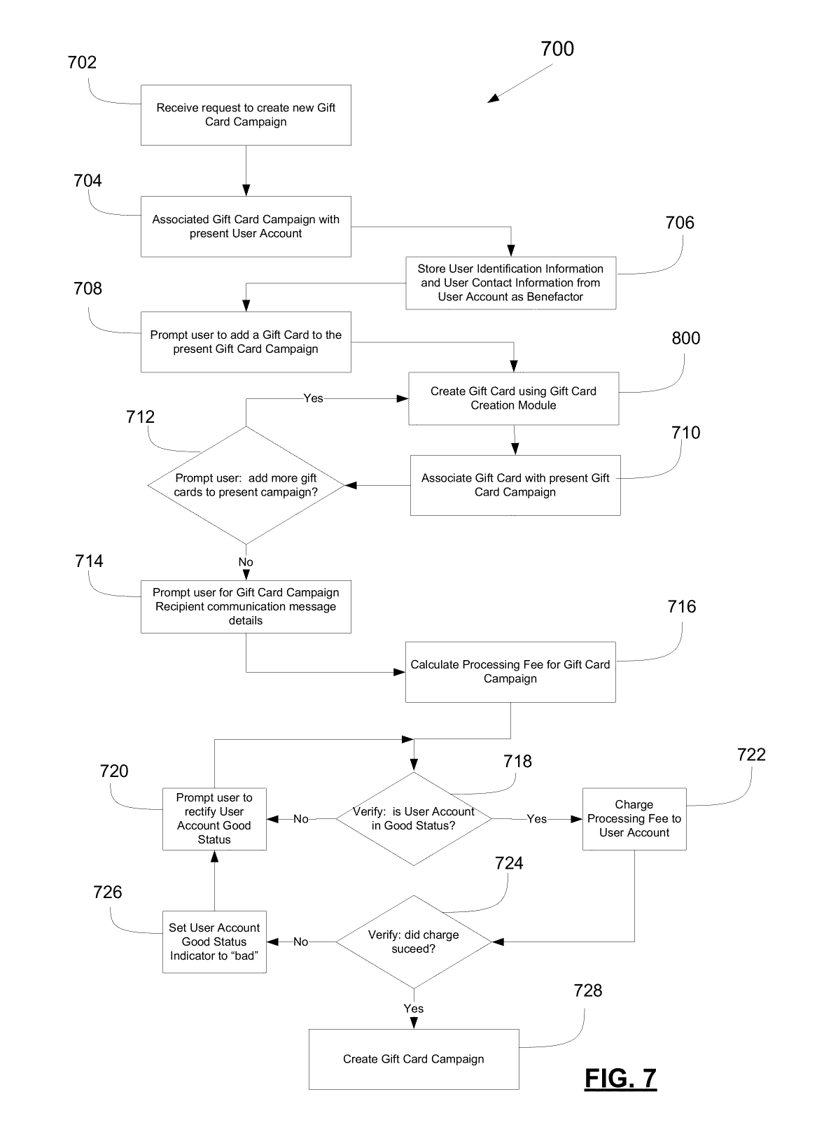

Referring now to FIG. 7, illustrated therein is a schematic diagram of an exemplary configuration of a gift card campaign creation module 700. At 702, the module receives a request to create a new gift card campaign. In some cases, this request may come from a user, for example, a user associated with a user account, in which case the gift card campaign may be associated with the user account in 704.

At 706, the user identification and contact information associated with the user account may be stored as “benefactor” information.

At 708, the user is prompted to add a gift card to the gift card campaign. This may be accomplished, for example, with the use of a gift card creation module 800. According to some embodiments, a gift card campaign may be established in which each gift card in the gift card campaign has the same gift card value, or is redeemable for the same gift item as the other gift cards in the gift card campaign.

At 710, a gift card is associated with the gift card campaign. In some cases, there may be an option to include more than one gift card in a gift card campaign.

At 712, an enquiry may be made as to whether one or more additional gift cards should be included in the gift card campaign. If one or more additional gift cards should be included in the gift card campaign, then another gift card may be created, for example, using the gift card creation module 800.

When no additional gift cards are to be included in the gift card campaign, at 714 the module 700 prompts the user to provide communication and messaging details for the gift card campaign. For example, a message may be included with the delivery of the gift card, which may be a general message, a message unique to each recipient or to a specific group or class of recipients, based on a template message, or of any other format. Other details, such as the delivery time and date for the gift cards, or the validity period of the gift cards, may be included, in addition to any other information pertaining to the gift cards or the gift card campaign.

In some embodiments, a processing fee may be associated with a gift card campaign. For instance, at 716, a processing fee for the gift card campaign may be calculated. This processing fee may be determined in any manner, for example, based on the number of gift cards in the campaign, based on gift card value, based on the total gift card value for the campaign, based on the number of gifts given by the user including other campaigns, or based on any other information.

In some cases, the module 700 determines whether the user's user account is in good status, such as at 718. For example, if the user account is not in good status, than the user may be prompted to rectify the user account good status at 720 (e.g., via email, text message, etc.).

If the user account is in good status, then an attempt may be made to charge the processing fee to the user account at 722. If an attempt has been made to charge the processing fee to the user account at 722, then the success of this charge may be verified at 724. In some cases, if the charge at 722 was not successful at 724, then at 726, the user account good status may be set to “bad”, and the module may return to 720 to prompt the user to rectify the user account good status. However, if the charge at 722 was successful at 724, then the gift card campaign may be implemented at 728.

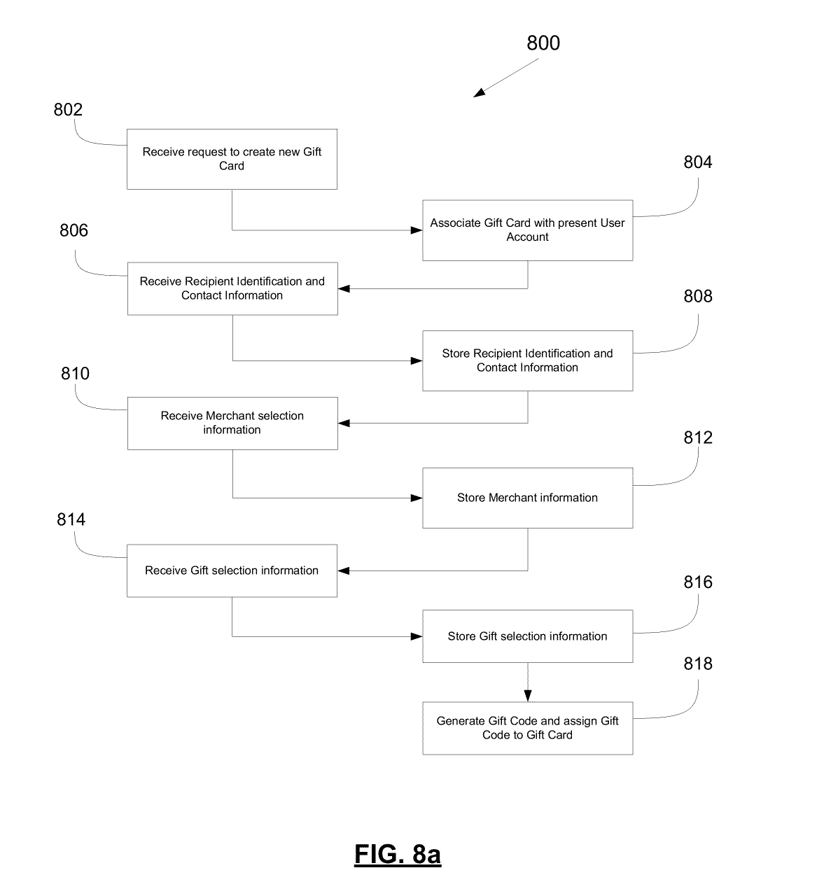

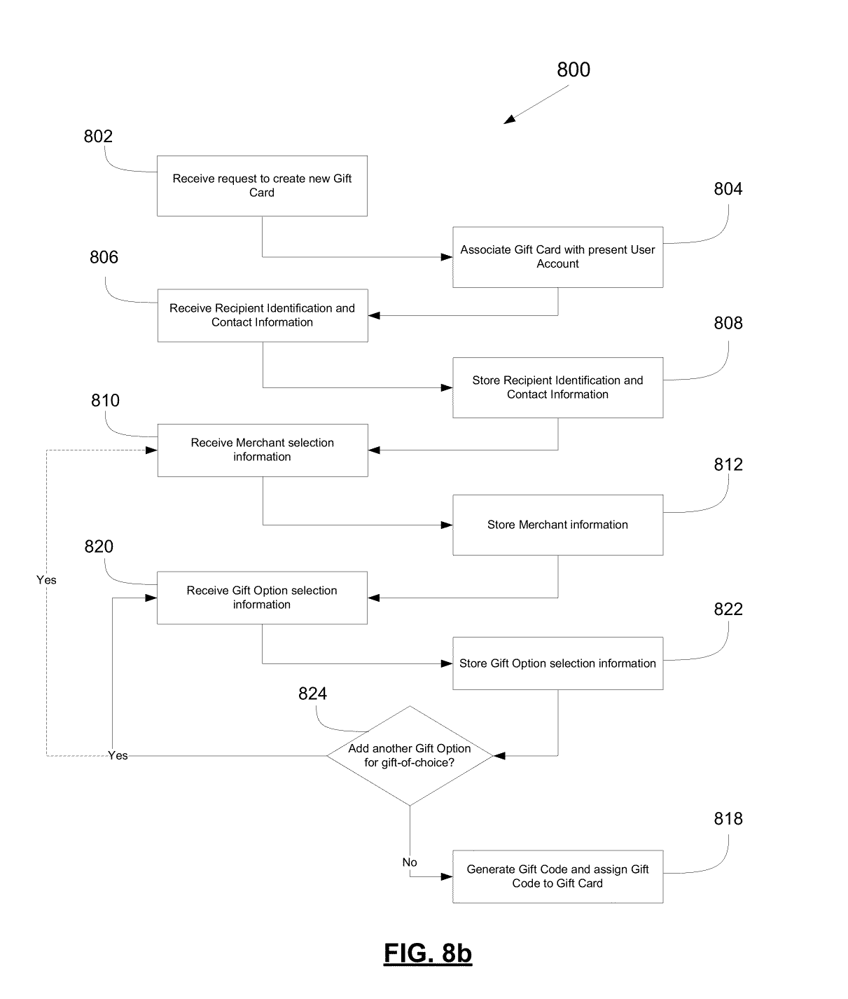

Referring now to FIG. 8A, illustrated therein is a schematic diagram of an exemplary configuration of a gift card creation module 800. At 802, a request to create a new gift card is received. For example, in some embodiments, this request may originate from gift card campaign creation module 700. In some cases, each gift card may be associated with a user account at 804. At 806 and 808, the module receives identification and contact information for the recipient of the gift card, and stores this information in association with the gift card that is being created. In some cases, at 810, the module may receive one or more particular merchants at which the gift card can be redeemed. In such cases, the merchant information may be stored at 812 in association with the gift card being created.

In some cases, at 814, the user may be able to select a particular gift or gift card value, or other value related to the redemption of the gift card. The gift or gift card value may be, for example, equivalent to a monetary value, or selected from a list of non-monetary goods or services (e.g. a free donut or coffee).

In some embodiments, any or all of the information related to 806, 810, and 814, for example recipient identification and contact information, merchant selection, gift selection, or other information, may be provided by a user each time the gift card creation module creates a gift card, in which case the user may be prompted to enter this information for each gift card. In other embodiments, any or all of the information related to 806, 810, and 814 may be provided by a user each time the gift card campaign creation module creates a gift card campaign, in which case a user may be prompted to enter any or all of the information, for example, related to 806, 810, and 814, once for each gift card campaign. Any or all of the information, for example, related to 806, 810, and 814 may be received by the gift card campaign creation module and subsequently communicated to the gift card creation module. Embodiments may include any combination of the information, for example, related to 806, 810, and 814 being received from a user in either the gift card campaign creation module, the gift card creation module, or both.

According to some embodiments, the gift or gift card value, or other value related to the redemption of the gift card may be stored in association with the gift card at 816. In some cases, a unique gift code may be generated at 818, assigned to the gift card, and stored in association with the gift card. For example, this gift code may be a unique identifier specific to a particular gift card.

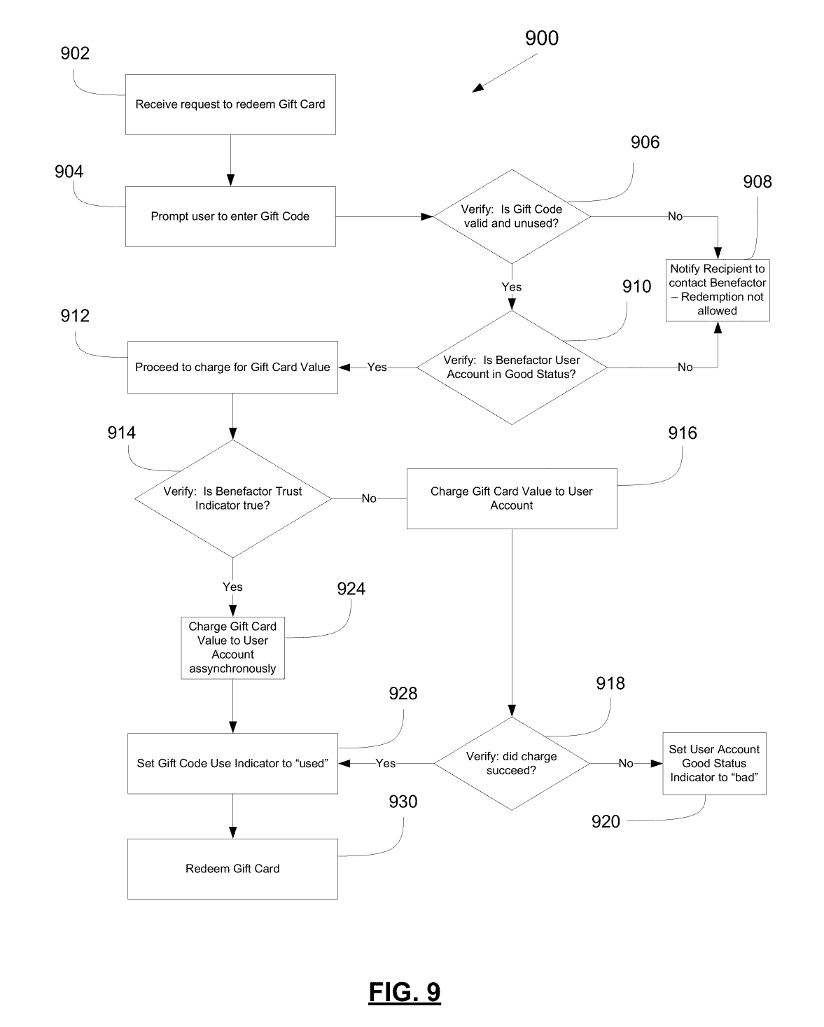

Referring now to FIG. 9, illustrated therein is a schematic diagram of an exemplary configuration of a gift card redemption module 900. At 902, a request to redeem a gift card may be received. For example, this may be initiated by a recipient presenting a gift card or gift code to a merchant. In some cases, the merchant may use one or more devices 20a-20e having dedicated software, or the merchant may use a web browser application through a web interface to provide the request.

According to some embodiments, the user, such as a merchant or recipient, may provide gift card information such as a gift code to the module at 904. At 906, the module may verify whether the gift card information, for example, a gift code, is valid and unused. A gift card may be invalid if, for example, it was not properly generated and authenticated by the gift card system, was conveyed through fraudulent means, or is otherwise invalid.

In some cases, if a gift card is deemed to be previously used, it may not be eligible for future redemption.

At 908, the recipient and merchant may be notified that the gift card redemption should not proceed because, for example, the gift code is invalid or has been previously used.

If the gift code or gift card information are deemed to be valid, or in some cases, unused at 906, then, according to some embodiments, the module may enquire whether the benefactor's user account is in good status at 910. If the benefactor's user account is not in good status, then the recipient or merchant (or both) may be notified that the gift card redemption should not proceed at 908. In some cases, at 912, if the benefactor's user account is in good status, then the module will proceed to attempt the charge the benefactor or the benefactor's user account for the gift card value.

In some cases, the module may enquire whether the benefactor is a trusted user of the gift card system at 914. For example, if the benefactor does not have “trusted” status, then the gift card value may be charged to the benefactor's user account at 916.

According to some embodiments, once the charge at 916 has been attempted, the module may verify that the charge was successful at 918. If the charge was not successful at 918, then, in some cases, the user account status may be set to “bad” as in 920 (for example via the user account maintenance module 600).

In some cases, if the charge was successful at 918, then the gift code, gift card information, gift code use indicator, or some other indicator, may be set to a value such as “used” at 928, which may indicate that the gift card or gift code should not be allowed for subsequent redemptions. In other cases, the gift code use indicator may be set to a value, for example, “used”, prior to the verification that a charge for the gift card value has been successful.

According to some embodiments, when a successful charge for the gift card value has been made, and the gift code use indicator has been set to “used”, the user, such as the merchant or recipient or other user, may be notified to proceed with the gift card redemption at 930.

According to some embodiments, certain events may be determined to be trigger events for the purposes of evaluating the trust indicator. For example, the creation of a campaign, the addition of a new credit card to a user account, and permitting gift code redemption prior to charging a credit card associated with a user account may be deemed “trigger events.”

Each trigger event may be associated with a unique trust indicator threshold. For example, if the trust indicator threshold associated with the addition of a new credit card is not met by a user's trust indicator, then the user will not be allowed to add a new credit card.

Referring now to FIG. 2b, illustrated therein is part of a gift card campaign creation method 201 according to some embodiments. The part of a method 201 may be executed by one or more processors of the system 10 shown in FIG. 1 and described herein above. For example, the part of a method 201 may be executed as a part of a gift card creation method 200.

According to some embodiments, it is possible to provide a choice of delivery method for the gift card. For example, one choice may be to use the gift card system to deliver the gift card; while another choice may be to use a third-party system to deliver the gift card. The benefactor's own email address, for example, may constitute a third-party delivery system, or another third-party messaging system may be used.

Once a benefactor's user account has been specified for a campaign, such as after step 204 in FIG. 2a, a campaign can be created for the user account. At steps 210 and 212 respectively, the gift card system prompts the user to enter information pertaining to the gift card merchant and the gift card value.

At step 224, the gift card system verifies whether the gift card campaign will include gift of-choice gift cards. If the campaign includes gift of-choice gift cards, then step 210 and/or step 212 may be repeated for each gift option that is added to the list of gift options. If the campaign does not include gift of-choice gifts cards, or if there are no gift options to be added to the list of gift options for a gift of-choice gift card, then the method proceeds to 214.

At step 214, the gift card system prompts the user to indicate whether there will be additional gift cards included in the present campaign. If the user chooses to add more gift cards to the present campaign, then steps 210 and 212 may be repeated for teach gift card that the user chooses to add to the campaign, until no more gift cards are to be added.

When the gift card system verifies that the user does not intend to add more gift cards to the present campaign, the method proceeds from step 214 to step 226. At step 226, the gift card system verifies which delivery method the benefactor has chosen. The benefactor may choose to deliver the gift card using the gift card system, or the benefactor may choose to deliver the gift card using a third-party system. For example, a third-party system may include the benefactor sending a hyper link to a gift card using the benefactor's own email system.

If the campaign uses the gift card system to deliver the gift card (or a hyper link to the gift card), then the method proceeds to step 208b. At step 208b, the gift card system prompts the user to enter information pertaining to the gift card recipients associated with the gift card campaign. For example, the user may select recipients based on information contained within the gift card system. This information may include other user accounts, or a recipient list that has been created by a user. Once the user has provided the recipient information, the method proceeds to step 228.

At step 228, the user creates a customized message that will be sent to the recipients of the campaign. Once the message has been written by the user, then a summary of the campaign and related costs is shown at step 234. According to some embodiments, the method may then continue to 216 as has been previously described.

Referring now to FIG. 3c, illustrated therein is a part of a method 301 for redeeming a gift card according to some embodiments. The part of a method 301 may be included in a method 300 for redeeming a gift card, for example, by interchanging certain steps in the method 300 with those in the part of a method 301.

For example, a gift code may be set to a recipient at 304 as a step previous to the recipient requesting redemption of a gift code at 306. At step 306, a request to redeem the gift code is received, typically from the recipient. For example, the gift card recipient may identify the gift code to the merchant, and the merchant may enter the gift code in the gift card system.

At step 320, the gift card system verifies that the gift code is redeemable by the recipient. For example, this might include verifying that an expiry time period has not passed, verifying that a specified number of total redemptions have not yet been made in the campaign, verifying validity based on the recipient's location, verifying that the recipient belongs to a pre-determined list of valid recipients, etc. A description of further embodiments of step 320 is provided below and in FIG. 3d.

If the gift code is not redeemable by the Recipient, then, according to some embodiments, redemption of the gift code is refused.

When, in step 320, the gift card system verifies that the gift code is redeemable by the recipient, then, at step 324, the recipient may be presented with several choices. For example, the recipient may be presented with the choice of refusing the opportunity to redeem the gift code. The recipient may also be presented with the choice of redeeming the gift code directly for a gift. According to some embodiments, the recipient may also be presented with the choice of redeeming the gift code indirectly, such as by contributing the gift or gift value as a donation to be made to a third-party organization such as a charity.

If a recipient chooses to redeem the gift code directly for a gift, then subsequent steps may be required as specified by various embodiments. For example, in some embodiments, a gift code may be redeemable for a particular specified gift, whereas in other embodiments, the gift code may be redeemable for a gift of-choice. Gift codes that are redeemable for a gift of-choice require at least the additional step of the recipient selecting a particular gift from a list of available gifts.

If a recipient chooses to redeem the gift code for a donation to a charity, then subsequent steps may be required as specified by various embodiments. For example, in some embodiments, gift codes that are redeemable for a charitable donation may require at least the additional step of the recipient selecting a particular charity from a list of available charities.

Once a recipient has chosen a gift or a charitable donation for which to redeem the gift code, a charge related to the gift or donation may be made to the credit card associated with the benefactor's user account at 312.

Referring now to FIG. 3d, illustrated therein is one embodiment of a step 320, such as may be used in a method 300 for redeeming gift cards or part of a method 301 for redeeming gift cards. For example, the step 320 may be generally used to evaluate whether a gift code is redeemable by a particular recipient.

At step 320a, the gift card system verifies that the gift card campaign is still active. For example, this may include verifying that the current time is within a redemption time limit, if one exists for the particular gift card campaign. If the gift card campaign is not active, then the method proceeds to step 320h, and the recipient is prevented from redeeming the gift code. In some embodiments, the recipient cannot claim a gift, and is not shown a gift offer. On the other hand, if, at step 320a, the gift card system determines that the gift card campaign is still active, then the method proceeds to step 320b.

At step 320b, the gift card system verifies that there is a specified list of possible recipients for a particular gift card or gift card campaign. In some embodiments, this may mean verifying that the campaign is limited to the benefactor's contact list or a specified subset of the benefactor's contact list. For example, a particular gift card or gift card campaign may be valid for use by a pre-determined list of recipients. In such a case, a recipient may receive a gift card directly from the benefactor, or indirectly through a third party who may or may not also be a part of the pre-determined list of recipients.

If, at step 320b, the gift card system determines that no list of possible recipients has been specified, then the method proceeds to step 320c. In this case, according to some embodiments, step 320c may prompt the recipient to enter information required to verify that the particular recipient is authorized to redeem the gift code. For example, there may be an access code, coupon code, etc., which may be used to verify that a particular recipient is authored to redeem the gift code.

Once a recipient has provided eligibility information at step 320c, the method proceeds to step 320d. At step 320d, the gift card system verifies whether the recipient is eligible to redeem the gift code, according to the information entered at step 320c. If the gift card system determines that the particular recipient is eligible to redeem the gift code, then the method proceeds to step 320e. If, on the other hand, at step 320d, the particular recipient is not eligible to redeem the gift code, then the method proceeds to step 320h, and the recipient is prevented from redeeming the gift code.

Returning now to step 320b, the gift card system may determine that there is a specified list of possible recipients. For example, the gift card campaign may be limited to the benefactor's contact list or a specified subset of the benefactor's contact list. If, at step 320b, the gift card system determines that there is a specified list of possible recipients, then the method proceeds to step 320f.

At step 320f, the gift card system verifies that the recipient has been previously addressed in the gift card or gift card campaign. For example, if a gift card or gift code is delivered to a recipient via email or social media, the recipients email address or social medial user identification may be embedded a hyper link used to the gift card or gift code. Step 320f follows from step 320b since, if there is a specified list of possible recipients (e.g. as determined at step 320b), and if the recipients address can be determined since the recipient has been previously address (such as embedding the recipient's address in a hyper link to the gift card or gift code), then, at step 320f, the gift card system can verify that the recipient, as identified by his or her address, is included in the specified list of possible recipients.

If, at step 320f, the gift card system determines that the recipient has been previously addressed, and that the recipient is included in the specified list of possible recipients, then the method proceeds to step 320e. According to some embodiments, it may be possible to automatically determine that the recipient is included in the specified list of possible recipients. For example, if a list of possible recipients has been specified during the creation of the gift card or gift card campaign, and if only the specified list of possible recipients has been used to determine recipient addresses, then it follows naturally that any previously-used recipient address must necessarily be included in the list of possible recipients.

If, on the other hand, at step 320f, the gift card system determines that the recipient has not been previously addressed, then the method proceeds to step 320c. In this case, according to some embodiments, step 320c may prompt the recipient to enter his or her address, such as an email address.

Once a recipient has provided his or her address at step 320c, the method proceeds to step 320d. At step 320d, the gift card system verifies whether the recipient, as identified by his or her address, is eligible to redeem the gift code according to the address entered at step 320c. For example, a particular address may identify an eligible recipient even if the gift card or gift code was not originally delivered to that particular address. If the gift card system determines that, based on the address entered at step 320c, the recipient is eligible to redeem the gift code, then the method proceeds to step 320e.

At step 320e, the gift card system verifies that the recipient has not already claimed a gift from the campaign. For example, a recipient that receives a gift card or gift code, or a hyper link to a gift card or gift code may attempt to redeem the gift code more than once. Furthermore, a recipient may attempt to redeem more than one gift code associated with a particular gift card campaign. If, at step 320e, the gift card system determines that the recipient has already claimed a gift from the campaign, then the method proceeds to step 320h, and the recipient is prevented from redeeming the gift code. If, on the other hand, at step 320e, the recipient has not previously claimed a gift from the campaign, then the method proceeds to step 320g.

At step 320g, the gift card campaign verifies whether the recipient is in the allowed redemption location, if any such redemption location has been previously specified. For example, this may include determining the recipient's location based on the location of a mobile device used by the recipient for receiving and/or redeeming a gift card or gift code. If, at step 320g, the gift card system determines that the location-based restrictions are not satisfied (e.g. that the recipient is outside of the allowed redemption location), then the method proceeds to step 320h, and the recipient is prevented from redeeming the gift code. If, on the other hand, the location-based restrictions are satisfied, then the method made proceed with the general redemption process. According to one embodiment, proceeding with the general redemption process may mean proceeding, for example, to step 324 as in FIG. 3c.

Referring now to FIG. 8b, illustrated therein is a schematic diagram of an exemplary configuration of a gift card creation module 800. According to some embodiments, it is possible to create a gift card that includes a gift of-choice. In the case of a gift of-choice gift card, a recipient may be presented with a list of gift options, and may select one of the gift options during the redemption process.

At 802, a request to create a new gift card is received. For example, in some embodiments, this request may originate from a gift card campaign creation module 700. In some cases, each gift card may be associated with a user account at 804. At 806 and 808, the module receives identification and contact information for the recipient of the gift card, and stores this information in association with the gift card that is being created. In some cases, at 810, the module may receive one or more particular merchants at which the gift card can be redeemed. In such cases, the merchant information may be stored at 812 in association with the gift card being created.

In some cases in which a gift of-choice is included, at 820, the user may be able to select a particular gift option or gift option value, or other value related to the redemption of the gift card, as a gift of-choice gift option. The gift option or gift option value may be, for example, equivalent to a monetary value, or selected from a list of non-monetary goods or services (e.g. a free donut or coffee).

According to some embodiments, the gift option or gift option value, or other value related to the redemption of the gift card may be stored in association with the gift card at 822, thereby creating a list of gift options. At step 824, the gift card system verifies whether another gift option is to be added to the list of gift options for the gift of-choice gift card. For example, at 824, the gift card system may prompt the user to decide whether another gift option is to be added to the list of gift options for the gift of-choice gift card.

If, at step 824, the gift card system determines that another gift option is to be added to the list of gift options, then the method may return to step 820. For example, multiple gift options from the same merchant can be included in the list of gift options by repeating the steps of 820 and 822 multiple times.

According to some embodiments, it is possible to add multiple gift options from multiple merchants to the list of gift options. For example, if, at step 824, the gift card system determines that another gift option is to be added to the list of gift options, then the method may return to step 810, as indicated by the dashed line in FIG. 8b. Multiple gift options from multiple merchants can be included in the list of gift options by repeating steps 810, 812, 820, and 822 multiple times.

In some cases, a unique gift code may be generated at 818, assigned to the gift card, and stored in association with the gift card. For example, this gift code may be a unique identifier specific to a particular gift card.

It should be understood that in other embodiments, one or more steps of the above described methods may be modified. In particular, one or more of the steps may be omitted, executed in a different order and/or in parallel, and there may be additional steps.

It should be understood that even though the embodiments are described herein in relation to gift card systems, they may be applicable in other fields of technology.

While the above description provides examples of one or more apparatus, methods, or systems, it will be appreciated that other apparatus, methods, or systems may be within the scope of the present description as interpreted by one of skill in the art. We claim one or more systems, methods and apparatus for post-payment of gift cards that include one or more elements as specifically and generally described herein and shown in the accompanying figures.

1. A gift administration system comprising:
a gift card creation module; and
a gift card campaign creation module for creating a campaign related to the at least one gift card; and

2. The gift card administration system of claim 1, further comprising a gift card redemption module for redeeming the at least one gift card.

3. The system of claim 1, wherein the gift card creation module comprises:
a user identification information for identifying a user;
a user identification contact information for addressing communications to the user;
a payment method information for identifying a payment method pertaining to the user;
at least one merchant information; and,
at least one gift value information;

4. The system of claim 1, wherein at least two merchants' information are used in order to provide a choice of merchants to the user.

5. The system of claim 1, wherein the gift value information is a gift selection information, and at least two gift selections' information are used in order to provide a choice of gift selections to the user.

6. The system of claim 1, further comprising a user account maintenance module for updating or refreshing information pertaining to the user account.

7. The system of claim 6, wherein the information pertaining to the user account comprises a trust indicator for indicating the extent to which the user account can be relied upon for a future post-redemption payment.

8. The system of claim 6, wherein the information pertaining to the user account comprises a good status indicator for indicating that a viable form of payment is associated with the user account.

9. A method for creating a gift card campaign, the method comprising:
receiving information pertaining to at least one second user from a first user, wherein the at least one second user is a recipient and the first user is a benefactor;
receiving information pertaining to a at least one vendor;
receiving information pertaining to a at least one gift card value;
verifying that a good status indicator of a user account associated with the benefactor is satisfied;
associating at least one gift code with the recipient, the at least one benefactor, the at least one vendor, and the at least one gift card value.

10. The method of claim 9, further comprising:
associating information pertaining to a first vendor with information pertaining to a first gift card value, such that a first gift option is defined by the first vendor information and first gift card value; and,
associating information pertaining to a second vendor with information pertaining to a second gift card value, such that a second gift option is defined by the second vendor information and second gift card value.

11. The method of claim 9, further comprising calculating a trust indicator associated with the benefactor's user account based on the benefactor's behavior during user events.

12. The method of claim 11, further comprising:
(a) evaluating the trust indicator;
(b) verifying whether a particular step in the method may proceed based on a trust indicator threshold associated with the particular step; and,
(c) refusing the particular step in the method if and only if the trust indicator is above the trust indicator threshold.

13. A method for redeeming a gift card, comprising:
prompting a first user to enter a gift code pertaining to the gift card;
verifying that a use indicator associated with the gift card indicates that the gift code is valid and unused;
processing a charge corresponding to a gift card value associated with the gift card to a benefactor's user account; and
setting the gift code use indicator to indicate that the gift code has been used.

14. The method of claim 13, further comprising verifying that a good status indicator associated with the benefactor's user account has a value that indicates a good status.

15. The method of claim 13, further comprising verifying whether the charge to the benefactor's user account was successful, and:
If and only if the charge was successful, setting the good status indicator value to a good status; and
If and only if the charge was not successful, setting the good status indicator value to a bad status.

16. The method of claim 13, further comprising providing a recipient of the gift card with the choice:
(a) to redeem the gift code directly for a gift; or
(b) to redeem the gift code indirectly by assigning the gift card value to a third-party organization; or
(c) to refuse to redeem the gift code.

17. The method of claim 13, further comprising verifying that the gift campaign is still active.

18. The method of claim 13, further comprising prompting the first user to enter information required to verify that a particular recipient is authorized to redeem the gift code.

19. The method of claim 13, further comprising verifying that a gift card recipient is included on a specified list of possible recipients.

20. The method of claim 13, further comprising
verifying that the first user is not included on a specified list of possible recipients;
receiving information pertaining to a recipient associated with the gift code during creation of the gift card;
verifying that the recipient associated with the gift code during creation of the gift card is on a specified list of possible recipients; and,
verifying that the gift code is eligible to be transferred from the recipient associated with the gift code during creation of the gift card and the first user.

21. The method of claim 13, further comprising verifying that the first user is within an allowed redemption location.
